(19) United States
(12) Patent Application Publication
(10) Pub. No.: US 2014/0153289 A1
(43) Pub. Date: Jun. 5, 2014

(54) Secondary Side Serial Resonant Full-Bridge DC/DC Converter

(71) Applicant: CHUNG-SHAN INSTITUTE OF SCIENCE AND TECHNOLOGY, Longtan Township (TW)

(72) Inventors: Chien-Min Kao, Longtan Township (TW); Gwo-Huei You, Longtan Township (TW); Kun-Feng Chen, Longtan Township (TW); Kuo-Kuang Jen, Longtan Township (TW); Yu-Min Liao, Longtan Township (TW)

(73) Assignee: CHUNG-SHAN INSTITUTE OF SCIENCE AND TECHNOLOGY, Longtan Township (TW)

(21) Appl. No.: 13/689,755

(22) Filed: Nov. 30, 2012

(51) Int. Cl. H02M 3/335

(52) U.S. Cl. CPC H02M 3/33569
USPC 363/17

(57) ABSTRACT

The present invention relates to a secondary side serial resonant full-bridge DC/DC converter, comprising: a transistor full-bridge unit, a transformer unit, a resonant unit, a rectifying unit, and an output unit. Particularly, in the present invention, a resonant inductor and a resonant capacitor of the resonant unit and a load resistor of the output unit constitute a serial resonant circuit having a serial resonant frequency; therefore, when the circuit frequency is operated on the serial resonant frequency, the resonant inductor impedance would be offset by the resonant capacitor impedance, such that the circuit is operated in the zero current switch (ZCS) region, and the output voltage variation can be controlled in ±0.2%. Moreover, through the serial resonant circuit, the issue about the resonant components hard to be designed due to their small characteristic impedance can simultaneously be improved.

### BACKGROUND OF THE INVENTION

1. Field of the Invention

The present invention relates to a DC voltage converter, and more particularly to a secondary side serial resonant full-bridge DC/DC converter.

2. Description of the Prior Art

The conventional electrical/electronic equipments, such as TV, stereo set or computer, the components in the interior thereof are powered by DC power. Thus, when supplying power to those components, a power supply (or a rectifier) is necessary and used for transforming the municipal electricity (AC power) to various DC voltage (DC power), therefore the components in the electrical/electronic equipments can be driven by the DC voltage.

Currently, power supplies are divided into linear power supply and switch power supply. Please refer to FIG. 1, which illustrates a framework diagram of a conventional linear power supply. As shown in FIG. 1, simple linear power supply 1′ consists of transformer T′, diode D1′, diode D2′, capacitor C′, regulator R-C′, and load resistor R_{L}′, wherein the two diodes D1′ and D2′ constitute a rectifier, and the capacitor C′ is used for filtering. The aforesaid linear power supply 1′ includes the advantages of simple circuit and high stability; however, the transformer T′ used in the linear power supply 1′ cannot be directly installed in a printed circuit board due to its large volume and heavy weight. Besides that the transformer T′ cannot be directly installed in PCB, the primary drawbacks of the linear power supply 1′ are low conversion efficiency (about 30˜50%) and not allowing for DC input.

Accordingly, for overcoming the drawbacks of the conventional linear power supply 1′, switch mode power supply (SMPS) is proposed and developed. Switch power supply can provide power to components for rapid switching purpose through pulse width modulation (PWM). So that, comparing to the conventional linear power supply 1′, switch power supply shows the advantages of high conversion efficiency, light weight and small volume.

Although the switch power supply has the advantages of high conversion efficiency, light weight and small volume, it still includes the shortcomings and drawbacks as follows:

(1) The half-bridge series resonant converter in the input terminal of the switch power supply can be merely used in the operation of high voltage input and low voltage output. Once the half-bridge series resonant converter is used in the operation of low voltage input and high voltage output, the reflective impedance produced in the primary side of transformer and induced by load would become extremely small, therefore the characteristic impedance would be very small if the quality factor is small (characteristic impedance=reflective impedance x quality factor), such that the resonant components are hard to be designed due to their small characteristic impedance;
(2) When the series resonant converter is used in the operation of low voltage input and high voltage output, it is adopted for being operated in zero current switch (ZCS) region for high switching current in the primary side of transformer; in addition, because the switch frequency is smaller than the resonant frequency in the zero current switch region, the output voltage of the series resonant converter cannot be effectively modulated when being light-load operated; and
(3) Hard switching technology used in the conventional switch power supply often brings much switching loss; for this reason, the operation frequency and the volume of heat-sink mechanism in the switch power supply must be increased, and that causes the whole volume of the power supply cannot be reduced eventually.

Thus, in view of the conventional linear power supply and switch power supply still have shortcomings and drawbacks, the inventor of the present application has made great efforts to make inventive research thereon and eventually provided a secondary side serial resonant full-bridge DC/DC converter.

### SUMMARY OF THE INVENTION

The first objective of the present invention is to provide a secondary side serial resonant full-bridge DC/DC converter, in which a serial resonant circuit consisting of a resonant inductor, a resonant capacitor and a load resistor is connected to the secondary side of a transformer unit, therefore, through the serial resonant circuit, the issue about the resonant components hard to be designed due to their small characteristic impedance can simultaneously be improved.

Accordingly, to achieve the primary objective of the present invention, the inventor of the present invention provides a secondary side serial resonant full-bridge DC/DC converter, which is applied in a switching power converter for operating a zero voltage switch (ZVS) and a zero current switch (ZCS), the second-side serial resonant full-bridge DC/DC converter comprising:

a transistor full-bridge unit, comprising a first MOSFET, a second MOSFET, a third MOSFET, and a fourth MOSFET and coupled to an input voltage signal for processing the full cycle rectification for the input voltage signal;

a transformer unit, coupled to the transistor full-bridge unit and having a turn ratio of 1:N between the primary side coil and the secondary side coil thereof, wherein the full-cycle rectified input voltage signal is transmitted to the secondary side coil from the primary side coil, so as to be transformed to a secondary side voltage signal;

a resonant unit, coupled to the transformer unit and having a resonant inductor and a resonant capacitor;

a rectifying unit, coupled to the resonant unit and the transformer unit for further rectifying the secondary side voltage signal; and

an output unit, coupled to the rectifying unit and having a load resistor;

wherein the resonant inductor, the resonant capacitor and the load resistor constitute a serial resonant circuit having a serial resonant frequency; therefore, when the circuit frequency is operated on the serial resonant frequency, the resonant inductor impedance would be offset by the resonant capacitor impedance, such that the secondary side voltage signal can be losslessly transmitted to the load resistor, and then be further outputted.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein::

FIG. 1 is a framework diagram of a conventional linear power supply;

FIG. 2 is a block diagram of a secondary side serial resonant full-bridge DC/DC converter according to the present invention;

FIG. 3 is a circuit diagram of the secondary side serial resonant full-bridge DC/DC converter according to the present invention;

FIG. 4 is a frequency response plot of the output voltage of the secondary side serial resonant full-bridge DC/DC converter;

FIG. 5 is a timing chart of the output voltage of the secondary side serial resonant full-bridge DC/DC converter in the zero current switch (ZCS) region; and

FIGS. 6A, 6B and 6C are oscilloscope-measuring waveform drawings of the secondary side serial resonant full-bridge DC/DC converter.

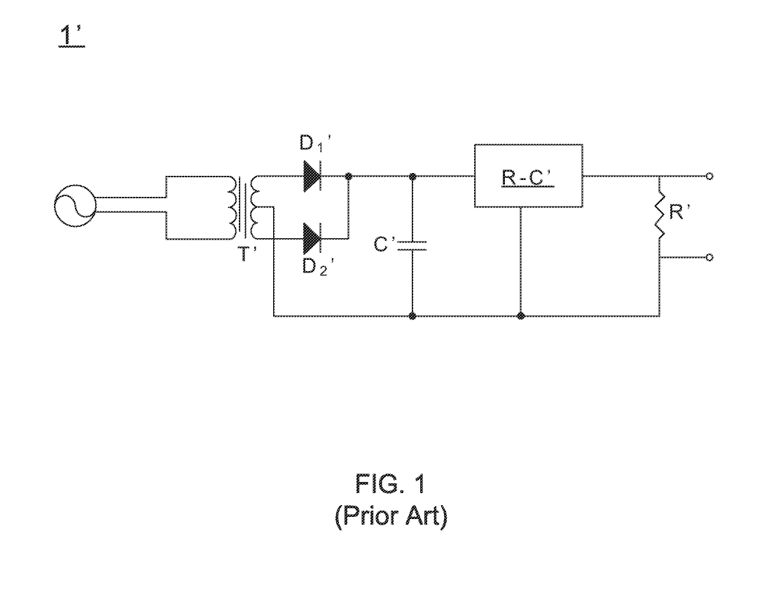

### DETAILED DESCRIPTION OF THE PREFERRED EMBODIMENTS

To more clearly describe a secondary side serial resonant full-bridge DC/DC converter according to the present invention, embodiments of the present invention will be described in detail with reference to the attached drawings hereinafter.

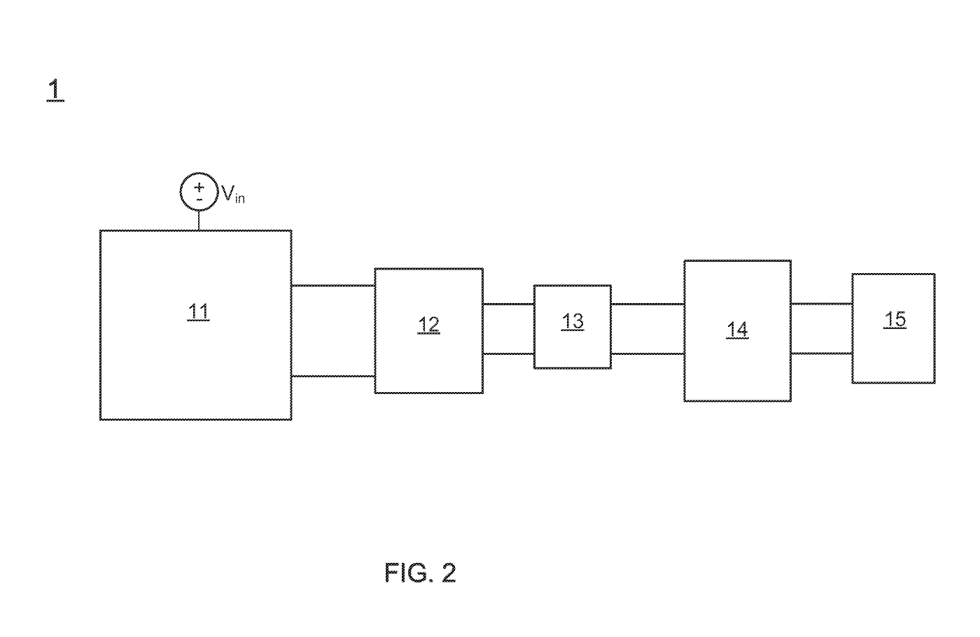

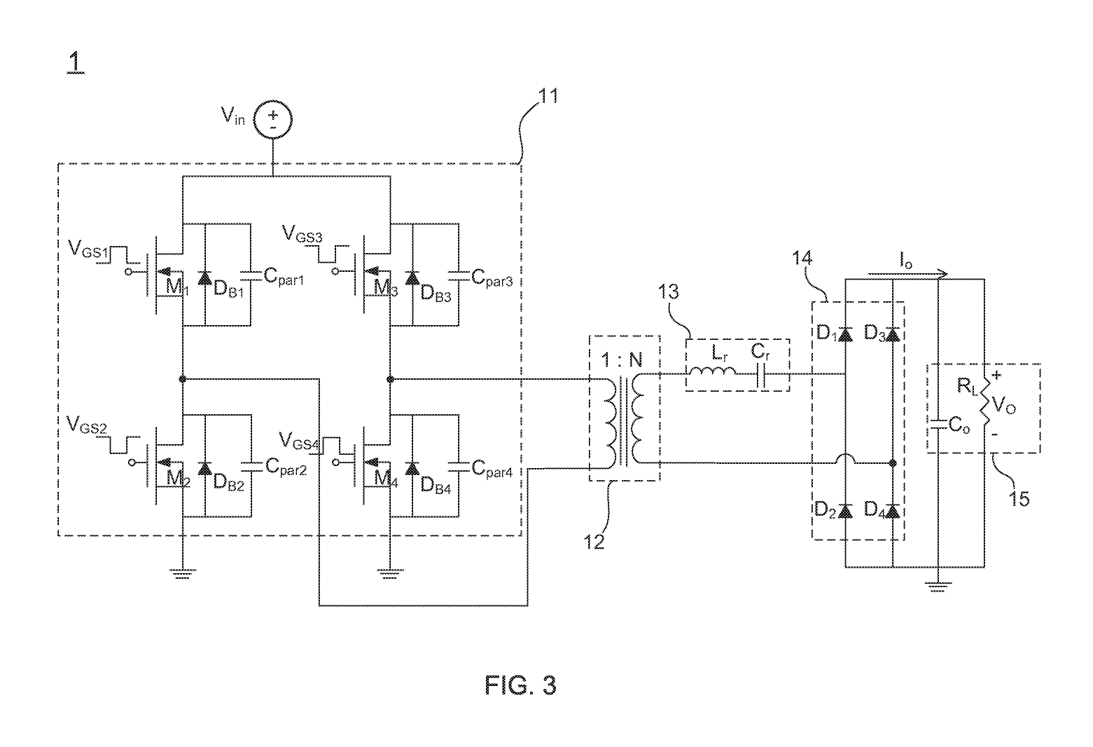

Please refer to FIG. 2 and FIG. 3, there are shown a block and a circuit diagrams of the secondary side serial resonant full-bridge DC/DC converter according to the present invention. As shown in FIG. 2 and FIG. 3, the secondary side serial resonant full-bridge DC/DC converter 1 is applied in a switching power converter for operating a zero voltage switch (ZVS) and a zero current switch (ZCS), and includes: a transistor full-bridge unit 11, a transformer unit 12, a resonant unit 13, a rectifying unit 14, and an output unit 15; in which, the transistor full-bridge unit 11 consists of a first MOSFET M₁, a second MOSFET M₂, a third MOSFET M₃, and a fourth MOSFET M₄, and the transistor full-bridge unit 11 is coupled to an input voltage signal for processing the full cycle rectification for the input voltage signal.

In addition, as shown in FIG. 3, the first MOSFET M₁, the second MOSFET M₂, the third MOSFET M₃, and the fourth MOSFET M₄ respectively have a first body diode D_{B1}, a second body diode D_{B2}, a third body diode D_{B3}, and a fourth body diode D_{B4} in the interior thereof; moreover, the first MOSFET M₁, the second MOSFET M₂, the third MOSFET M₃, and the fourth MOSFET M₄ also respectively have a first parasitic capacitor Cₚₐᵣ₁, a second parasitic capacitor Cₚₐᵣ₂ a third parasitic capacitor Cₚₐᵣ₃, and a fourth parasitic capacitor Cₚₐᵣ₄ in the interior thereof.

Continuously, the transformer unit 12 is coupled to the transistor full-bridge unit 11, and the turn ratio between the primary side coil and the secondary side coil of the transformer unit 12 is 1:N. In this secondary side serial resonant full-bridge DC/DC converter 1, the full-cycle rectified input voltage signal is transmitted to the secondary side coil from the primary side coil for being transformed to a secondary side voltage signal, such that the amplitude of the secondary side voltage signal is N times greater than the amplitude of the input voltage signal. The resonant unit 13 is coupled to the transformer unit 12 and has a resonant inductor Lᵣ and a resonant capacitor Cᵣ, and the rectifying unit 14 is coupled to the resonant unit 13 and the transformer unit 12 for further rectifying the secondary side voltage signal. In the present invention, the rectifying unit 14 consists of a first diode D₁, a second diode D₂, a third diode D₃, and a fourth diode D₄, wherein the first diode D₁ is series connected to the second diode D₂, the third diode D₃ is series connected to the fourth diode D₄, and the first diode D₁ and the second diode D₂ are parallel connected to the third diode D₃ and the fourth diode D₄.

Furthermore, the output unit 15 is coupled to the rectifying unit 14 and has a load resistor R_{L} and an output capacitor Cₒ, wherein the output capacitor Cₒ is parallel connected to the load resistor R_{L} for filtering the non-DC signal on the secondary side voltage signal. Particularly, in the present invention, the resonant inductor Lᵣ, the resonant capacitor Cᵣ and the load resistor R_{L} constitute a serial resonant circuit having a serial resonant frequency fᵣ (fr is not an element numeric/symbol, but is a mathematical symbol.). Thus, when the circuit frequency is operated on the serial resonant frequency fᵣ, the resonant inductor Lᵣ impedance would be offset by the resonant capacitor Cᵣ impedance, such that the secondary side voltage signal can be losslessly transmitted to the load resistor R_{L}, so as to be outputted.

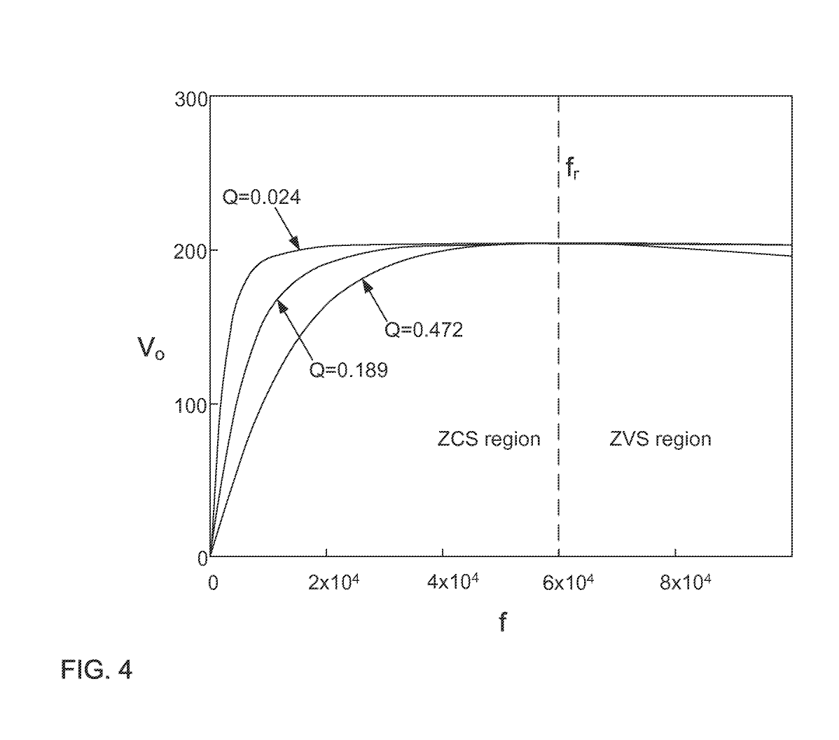

Thus, through the descriptions, the circuit framework and components of the secondary side serial resonant full-bridge DC/DC converter have been completely introduced and disclosed. Next, the technology features and performances of the secondary side serial resonant full-bridge DC/DC converter will be presented through various experiment data. Please refer to FIG. 4, which illustrates a frequency response plot of the output voltage of the secondary side serial resonant full-bridge DC/DC converter. As shown in FIG. 4, the serial resonant circuit reveals inductive character when the operation frequency (or switch frequency) fₛ is greater than the resonant frequency fᵣ, and meanwhile the circuit is operated in the zero voltage switch region. On the contrary, when the switch frequency fₛ is smaller than the resonant frequency fᵣ, the circuit is operated in the zero current switch region and the serial resonant circuit shows capacitive character. Besides, the circuit can be simultaneously operated in the zero voltage switch and the zero current switch if the switch frequency fₛ is equal to the resonant frequency fᵣ.

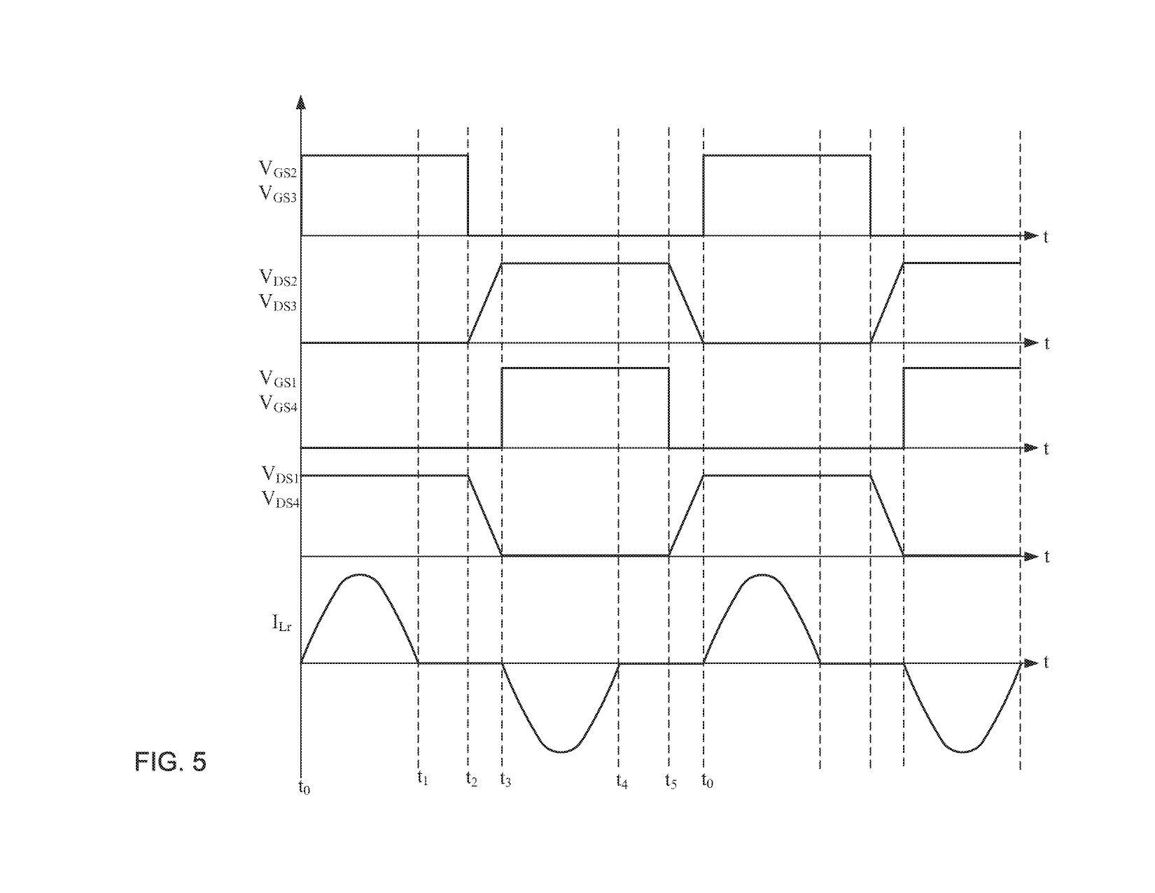

Please continuously refer to FIG. 5, there is shown a timing chart of the output voltage of the secondary side serial resonant full-bridge DC/DC converter in the zero current switch (ZCS) region. As shown in FIG. 5, when the operation frequency fᵣ is smaller than the resonant frequency fᵣ, the secondary side serial resonant full-bridge DC/DC converter is operated in the zero current switch (ZCS) region, such that the resonance induced by the resonant inductor Lᵣ and the resonant capacitor Cᵣ facilitates the secondary side serial resonant full-bridge DC/DC converter be adapted to process the voltage conversion with low voltage input and high voltage output.

Moreover, for improving the practicability of this secondary side serial resonant full-bridge DC/DC converter, the experiment data are presented in following table (1):

TABLE (1)

| | |
|---|---|
| Input voltage | Vᵢₙ = 12 V |
| Output voltage | V_{O} = 200 V ± 1% |
| Output current | I_{O} = 1.25 A~5 A |
| Switch frequency | fₛ = 10 kHz~60 kHz |
| Serial resonant frequency | fᵣ = 60 kHz |
| Turn ratio | N = N_{S}/N_{P} = 85/4 |
| Resonant inductor | Lᵣ = 68 μH |
| Resonant capacitor | Cᵣ = 0.11 μF |

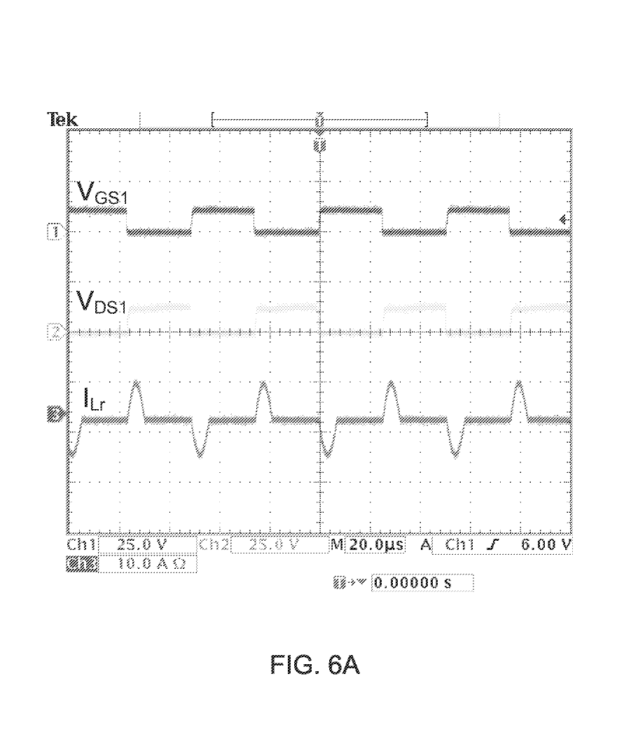

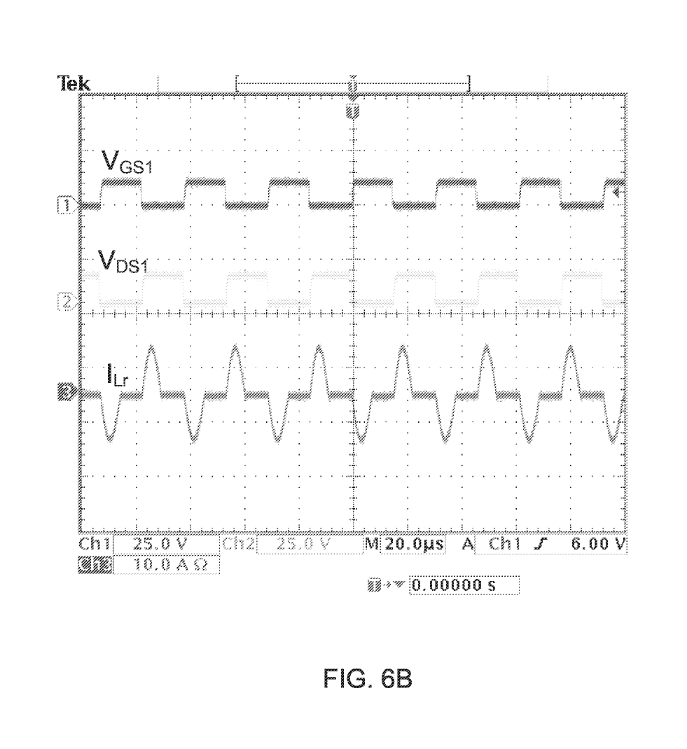

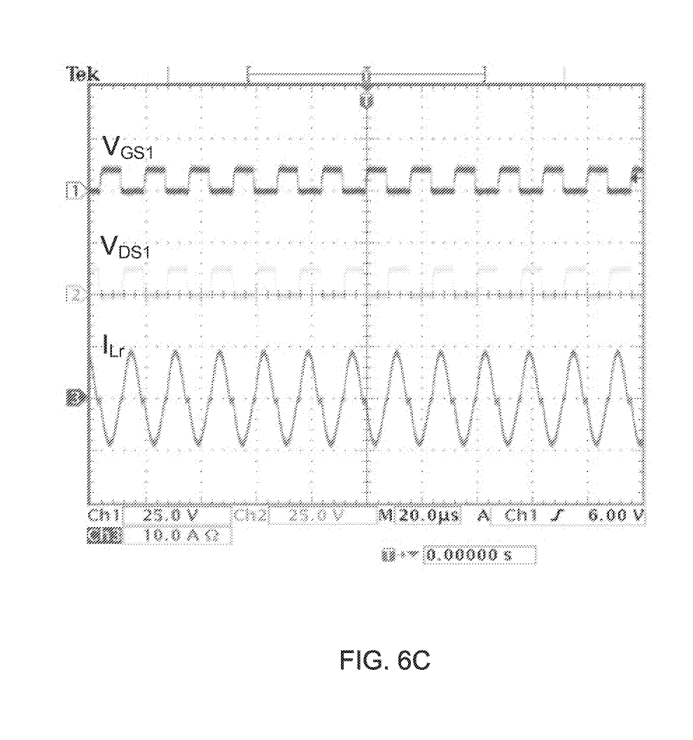

Please refer to FIG. 6A, FIG. 6B and FIG. 6C, there are shown oscilloscope-measuring waveform drawings of the secondary side serial resonant full-bridge DC/DC converter, in which the oscilloscope-measuring waveform shown in FIG. 6A is got at the operation frequency fₛ of 19.61 kHz, the oscilloscope-measuring waveform shown in FIG. 6B is obtained at the operation frequency fₛ of 32.32 kHz, and the oscilloscope-measuring waveform shown in FIG. 6C is measured at the operation frequency fₛ of 60.3 kHz. To make a comparison between the oscilloscope-measuring waveforms of FIG. 6A, FIG. 6B and FIG. 6C, it can find that the circuit is switched between ZCS turn on and ZCS turn off when the operation frequency is almost equal to the resonant frequency.

In addition, the relative measured data of the oscilloscope-measuring waveforms of FIG. 6A, FIG. 6B and FIG. 6C are listed in following table (2):

TABLE (2)

| Vᵢₙ | Iᵢₙ | V_{O} | I_{O} | fₛ | η |
|---|---|---|---|---|---|
| (V) | (A) | (V) | (A) | (Hz) | (%) |
| 12 | 24.64 | 200.9 | 1.2526 | 19.61k | 85.34 |
| 12 | 48.33 | 200.85 | 2.5 | 32.32k | 86.57 |
| 12 | 95.7 | 200.12 | 5 | 60.3k | 87.12 |

Through above table (2), it can easily find that the output voltage change can be controlled in ±0.2% if the secondary side serial resonant full-bridge DC/DC converter is operated in the zero voltage current region.

Thus, through the descriptions, the circuit framework, circuit components, technology features, and performances of the secondary side serial resonant full-bridge DC/DC converter have been completely introduced and disclosed; in summary, the present invention has the following advantages:

1. Through this secondary side serial resonant full-bridge DC/DC converter, the issue about the resonant components hard to be designed due to their small characteristic impedance can simultaneously be improved and solved; besides, by the relative measured data of the oscilloscope-measuring waveforms, it shows that the output voltage change can be controlled in ±0.2% if the secondary side serial resonant full-bridge DC/DC converter is operated in the zero voltage current region.
2. Moreover, through the relative measured data of the oscilloscope-measuring waveforms, the conversion efficiency η of the secondary side serial resonant full-bridge DC/DC converter proposed by the present invention is higher than 85%.

The above description is made on embodiments of the present invention. However, the embodiments are not intended to limit scope of the present invention, and all equivalent implementations or alterations within the spirit of the present invention still fall within the scope of the present invention.

What is claimed is:

1. A secondary side serial resonant full-bridge DC/DC converter, being applied in a switching power converter for operating a zero voltage switch (ZVS) and a zero current switch (ZCS), the second-side serial resonant full-bridge DC/DC converter comprising:
a transistor full-bridge unit, comprising a first MOSFET, a second MOSFET, a third MOSFET, and a fourth MOSFET and being coupled to an input voltage signal, so as to process the full cycle rectification for the input voltage signal;
a transformer unit, being coupled to the transistor full-bridge unit, and having a turn ratio of 1:N between the primary side coil and the secondary side coil thereof, wherein the full-cycle rectified input voltage signal is transmitted to the secondary side coil from the primary side coil, so as to be transformed to a secondary side voltage signal;
a resonant unit, being coupled to the transformer unit and having a resonant inductor and a resonant capacitor;
a rectifying unit, being coupled to the resonant unit and the transformer unit for further rectifying the secondary side voltage signal; and
an output unit, being coupled to the rectifying unit and having a load resistor;
wherein the resonant inductor, the resonant capacitor and the load resistor constitute a serial resonant circuit having a serial resonant frequency; therefore, when the circuit frequency is operated on the serial resonant frequency, the resonant inductor impedance would be offset by the resonant capacitor impedance, such that the secondary side voltage signal can be losslessly transmitted to the load resistor, so as to be outputted.

2. The secondary side serial resonant full-bridge DC/DC converter of claim 1, wherein the first MOSFET, the second MOSFET, the third MOSFET, and the fourth MOSFET respectively have a first body diode, a second body diode, a third body diode, and a fourth body diode in the interior thereof.

3. The secondary side serial resonant full-bridge DC/DC converter of claim 2, wherein the first MOSFET, the second MOSFET, the third MOSFET, and the fourth MOSFET respectively have a first parasitic capacitor, a second parasitic capacitor, a third parasitic capacitor, and a fourth parasitic capacitor in the interior thereof.

4. The secondary side serial resonant full-bridge DC/DC converter of claim 1, wherein the rectifying unit consists of a first diode, a second diode, a third diode, and a fourth diode, in which the first diode is series connected to the second diode, the third diode being series connected to the fourth diode, and the first diode and the second diode are parallel to the third diode and the fourth diode.

6. The secondary side serial resonant full-bridge DC/DC converter of claim 1, wherein the output unit further comprises a output capacitor, being parallel connected to the load resistor and used for filtering the non-DC signal on the secondary side voltage signal.
